(19) United States
(12) Patent Application Publication
(10) Pub. No.: US 2024/0089884 A1
(43) Pub. Date: Mar. 14, 2024

(54) GROUP DELAY MITIGATION IN RTT TECHNIQUE FOR ACCURACY ENHANCEMENT

(71) Applicant: MEDIATEK INC., Hsinchu City (TW)

(72) Inventor: Chiao-Yao CHUANG, Hsinchu City (TW)

(21) Appl. No.: 18/263,595

(22) PCT Filed: Jan. 28, 2022
(86) PCT No.: PCT/CN2022/074579

§ 371 Date: Jul. 31, 2023

Related U.S. Application Data
(60) Provisional application No. 63/236,262, filed on Aug. 24, 2021.
(60) Provisional application No. 63/169,265, filed on Apr. 1, 2021.
(60) Provisional application No. 63/154,023, filed on Feb. 26, 2021.
(60) Provisional application No. 63/145,050, filed on Feb. 3, 2021.

(51) Int. Cl. H04W 56/00

(52) U.S. Cl. CPC H04W 56/0045

(57) ABSTRACT

In an aspect of the disclosure, a method, a computer-readable medium, and an apparatus are provided. The apparatus may be a UE. The UE measures, at a baseband, a UE RX-TX time difference at-baseband. The UE compensates the UE RX-TX time difference at-baseband to estimate a UE RX-TX time difference at-antenna. The UE sends, to a network, the UE RX-TX time difference at-antenna with an indication that reference points are at antennas and an indication of a TX chain, or a timing delay error level of the TX chain, intended to be used by the UE during the measuring or the compensating.

### CROSS-REFERENCE TO RELATED APPLICATION(S)

This application claims the benefits of U.S. Provisional Application Ser. No. 63/145,050, entitled “PROCEDURE TO ASSIST NETWORK FOR TRANSMISSION TIMING CALIBRATION FOR POSITIONING ACCURACY ENHANCEMENT” and filed on Feb. 3, 2021; U.S. Provisional Application Ser. No. 63/154,023, entitled “FURTHER ENHANCEMENT FOR MULTIPLE-RTT FOR POSITIONING ACCURACY ENHANCEMENT” and filed on Feb. 26, 2021; U.S. Provisional Application Ser. No. 63/169,265, entitled “FURTHER ACCURACY ENHANCEMENT FOR MULTIPLE-RT TECHNIQUE” and filed on Apr. 1, 2021; and U.S. Provisional Application Ser. No. 63/236,262, entitled “ACCURACY ENHANCEMENT FOR M-RTT TECHNIQUE” and filed on Aug. 24, 2021; all of which are expressly incorporated by reference herein in their entirety.

### TECHNICAL FIELD

The present disclosure relates generally to communication systems, and more particularly, to techniques of positioning a user equipment (UE).

### BACKGROUND

The statements in this section merely provide background information related to the present disclosure and may not constitute prior art.

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. In an aspect of the disclosure, a method, a computer-readable medium, and an apparatus are provided. The apparatus may be a UE. The UE measures, at a baseband, a UE RX-TX time difference at-baseband. The UE compensates the UE RX-TX time difference at-baseband to estimate a UE RX-TX time difference at-antenna. The UE sends, to a network, the UE RX-TX time difference at-antenna with an indication that reference points are at antennas and an indication of a TX chain, or a timing delay error level of the TX chain, intended to be used by the UE during the measuring or the compensating.

In another aspect of the disclosure, a method, a computer-readable medium, and an apparatus are provided. The apparatus may be a base station. The base station measures, at a baseband, a base-station RX-TX time difference at-baseband. The base station compensates the base-station RX-TX time difference at-baseband to estimate a base-station RX-TX time difference at-antenna of a transmission and reception point (TRP) of the base station. The base station sending, to a location management function, the base-station RX-TX time difference at-antenna with an indication that reference points are at antennas and an indication of a TX chain, or a timing delay error level of the TX chain, used by the TRP during the measuring or the compensating.

In yet another aspect of the disclosure, a method, a computer-readable medium, and an apparatus are provided. The apparatus may be a location management function. The location management function receives, from a base station of a UE, a UE RX-TX time difference at-antenna with an indication that reference points associated with the UE RX-TX time difference at-antenna are at antennas of the UE. The location management function receives, from the base station, a base-station RX-TX time difference at-antenna with an indication that reference points associated with the base-station RX-TX time difference at-antenna are at antennas of a transmission and reception point (TRP) of the base station. The location management function receives a first association indication that the base-station RX-TX time difference at-antenna is associated with a TX chain or a timing delay error level of that TX chain. The location management function receives a second association indication that the UE RX-TX time difference at-antenna is associated with a TX chain or a timing delay error level of that TX chain. The location management function determines a time of flight of a signal transmitted between the TRP and the UE based on the UE RX-TX time difference at-antenna and the base-station RX-TX time difference at-antenna.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIG. 2 is a diagram illustrating a base station in communication with a UE in an access network.

FIG. 3 illustrates an example logical architecture of a distributed access network.

FIG. 4 illustrates an example physical architecture of a distributed access network.

FIG. 5 is a diagram showing an example of a DL-centric subframe.

FIG. 6 is a diagram showing an example of an UL-centric subframe.

FIG. 7 is a diagram illustrating communications among transmission and reception point (TRP) and user equipment (UE).

FIG. 8 is another diagram illustrating communications between TRPs and a UE.

FIG. 9 is a flow chart of a method (process) for determining a UE RX−TX time difference.

FIG. 10 is a flow chart of a method (process) for determining a base-station RX−TX time difference.

FIG. 11 is a flow chart of a method (process) for determining a time of flight.

FIG. 12 is a diagram illustrating an example of a hardware implementation for an apparatus employing a processing system.

FIG. 13 is a diagram illustrating an example of a hardware implementation for another apparatus employing a processing system.

FIG. 14 is a diagram illustrating an example of a hardware implementation for yet another apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

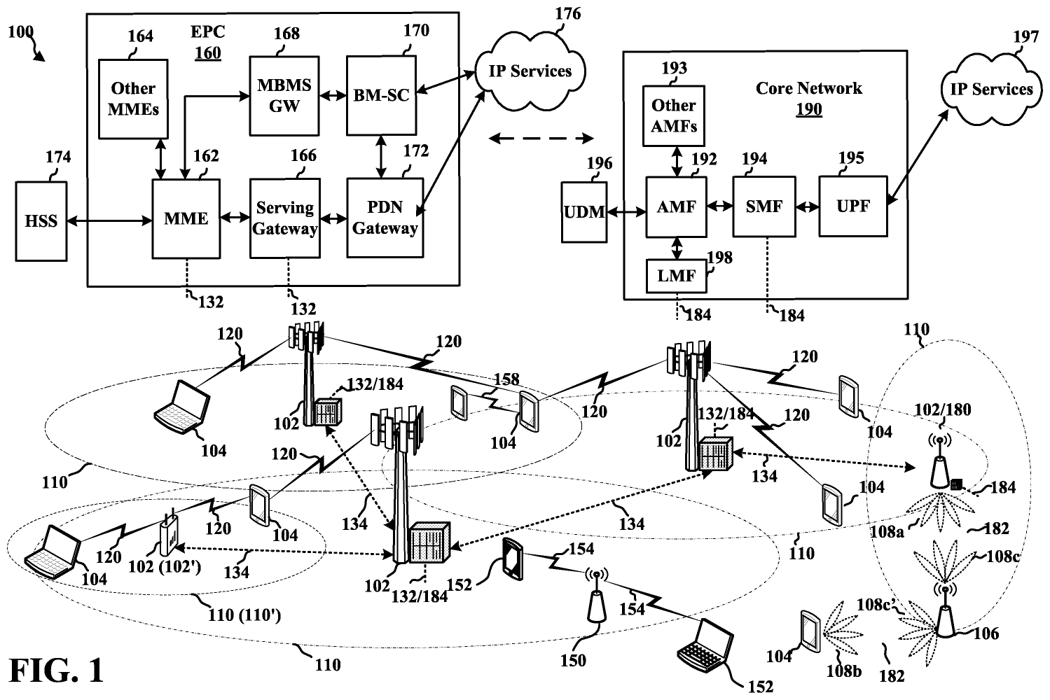

FIG. 1 is a diagram illustrating an example of a wireless communications system and an access network 100. The wireless communications system (also referred to as a wireless wide area network (WWAN)) includes base stations 102, UEs 104, an Evolved Packet Core (EPC) 160, and another core network 190 (e.g., a 5G Core (5GC)). The base stations 102 may include macrocells (high power cellular base station) and/or small cells (low power cellular base station). The macrocells include base stations. The small cells include femtocells, picocells, and microcells.

The base stations 102 configured for 4G LTE (collectively referred to as Evolved Universal Mobile Telecommunications System (UMTS) Terrestrial Radio Access Network (E-UTRAN)) may interface with the EPC 160 through backhaul links 132 (e.g., SI interface). The base stations 102 configured for 5G NR (collectively referred to as Next Generation RAN (NG-RAN)) may interface with core network 190 through backhaul links 184. In addition to other functions, the base stations 102 may perform one or more of the following functions: transfer of user data, radio channel ciphering and deciphering, integrity protection, header compression, mobility control functions (e.g., handover, dual connectivity), inter cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160 or core network 190) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per component carrier allocated in a carrier aggregation of up to a total of Y*x MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same GHz unlicensed frequency spectrum as used by the Wi-Fi AP 150. The small cell 102′, employing NR in an unlicensed frequency spectrum, may boost coverage to and/or increase capacity of the access network.

A base station 102, whether a small cell 102′ or a large cell (e.g., macro base station), may include an eNB, gNodeB (gNB), or another type of base station. Some base stations, such as gNB 180 may operate in a traditional sub 6 GHz spectrum, in millimeter wave (mmW) frequencies, and/or near mmW frequencies in communication with the UE 104. When the gNB 180 operates in mmW or near mmW frequencies, the gNB 180 may be referred to as an mmW base station. Extremely high frequency (EHF) is part of the RF in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and GHz, also referred to as centimeter wave. Communications using the mmW/near mmW radio frequency band (e.g., 3 GHz-300 GHz) has extremely high path loss and a short range. The mmW base station 180 may utilize beamforming 182 with the UE 104 to compensate for the extremely high path loss and short range.

The base station 180 may transmit a beamformed signal to the UE 104 in one or more transmit directions 108a. The UE 104 may receive the beamformed signal from the base station 180 in one or more receive directions 108b. The UE 104 may also transmit a beamformed signal to the base station 180 in one or more transmit directions. The base station 180 may receive the beamformed signal from the UE 104 in one or more receive directions. The base station 180/UE 104 may perform beam training to determine the best receive and transmit directions for each of the base station 180/UE 104. The transmit and receive directions for the base station 180 may or may not be the same. The transmit and receive directions for the UE 104 may or may not be the same.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia Subsystem (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The core network 190 may include an Access and Mobility Management Function (AMF) 192, other AMFs 193, a location management function (LMF) 198, a Session Management Function (SMF) 194, and a User Plane Function (UPF) 195. The AMF 192 may be in communication with a Unified Data Management (UDM) 196. The AMF 192 is the control node that processes the signaling between the UEs 104 and the core network 190. Generally, the SMF 194 provides QoS flow and session management. All user Internet protocol (IP) packets are transferred through the UPF 195. The UPF 195 provides UE IP address allocation as well as other functions. The UPF 195 is connected to the IP Services 197. The IP Services 197 may include the Internet, an intranet, an IP Multimedia Subsystem (IMS), a PS Streaming Service, and/or other IP services.

The base station may also be referred to as a gNB, Node B, evolved Node B (eNB), an access point, a base transceiver station, a radio base station, a radio transceiver, a transceiver function, a basic service set (BSS), an extended service set (ESS), a transmit reception point (TRP), or some other suitable terminology. The base station 102 provides an access point to the EPC 160 or core network 190 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Although the present disclosure may reference 5G New Radio (NR), the present disclosure may be applicable to other similar areas, such as LTE, LTE-Advanced (LTE-A), Code Division Multiple Access (CDMA), Global System for Mobile communications (GSM), or other wireless/radio access technologies.

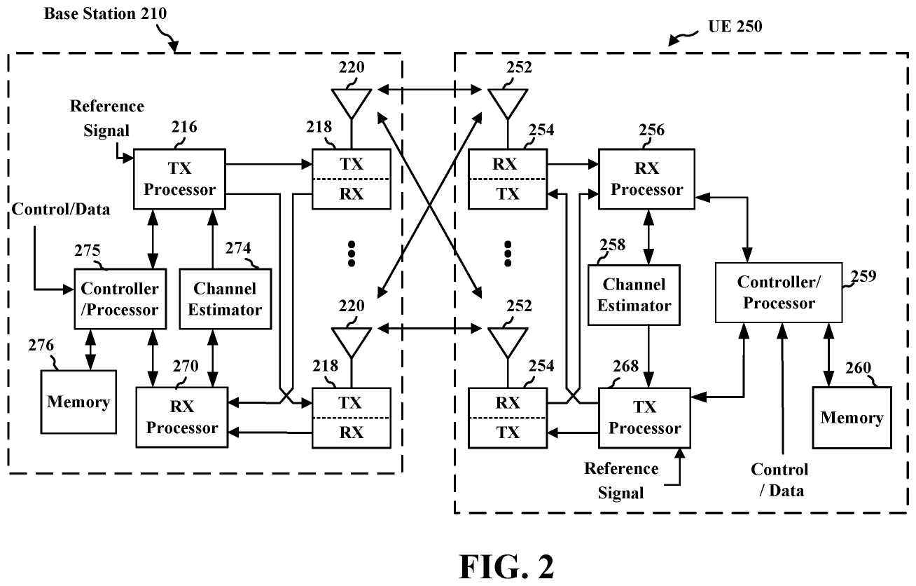

FIG. 2 is a block diagram of a base station 210 in communication with a UE 250 in an access network. In the DL, IP packets from the core network 160 may be provided to a controller/processor 275. The controller/processor 275 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 275 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 216 and the receive (RX) processor 270 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 216 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream may then be provided to a different antenna 220 via a separate transmitter 218TX. Each transmitter 218TX may modulate an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The TX processor 268 and the RX processor 256 implement layer 1 functionality associated with various signal processing functions. The RX processor 256 may perform spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 210. These soft decisions may be based on channel estimates computed by the channel estimator 258. The soft decisions are then decoded and deinterleaved to recover the data and control signals that were originally transmitted by the base station 210 on the physical channel. The data and control signals are then provided to the controller/processor 259, which implements layer 3 and layer 2 functionality.

The controller/processor 259 can be associated with a memory 260 that stores program codes and data. The memory 260 may be referred to as a computer-readable medium. In the UL, the controller/processor 259 provides demultiplexing between transport and logical channels, packet reassembly, deciphering, header decompression, and control signal processing to recover IP packets from the core network 160. The controller/processor 259 is also responsible for error detection using an ACK and/or NACK protocol to support HARQ operations.

Similar to the functionality described in connection with the DL transmission by the base station 210, the controller/processor 259 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 258 from a reference signal or feedback transmitted by the base station 210 may be used by the TX processor 268 to select the appropriate coding and modulation schemes, and to facilitate spatial processing. The spatial streams generated by the TX processor 268 may be provided to different antenna 252 via separate transmitters 254TX. Each transmitter 254TX may modulate an RF carrier with a respective spatial stream for transmission. The UL transmission is processed at the base station 210 in a manner similar to that described in connection with the receiver function at the UE 250. Each receiver 218RX receives a signal through its respective antenna 220. Each receiver 218RX recovers information modulated onto an RF carrier and provides the information to a RX processor 270.

The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover IP packets from the UE 250. IP packets from the controller/processor 275 may be provided to the core network 160. The controller/processor 275 is also responsible for error detection using an ACK and/or NACK protocol to support HARQ operations.

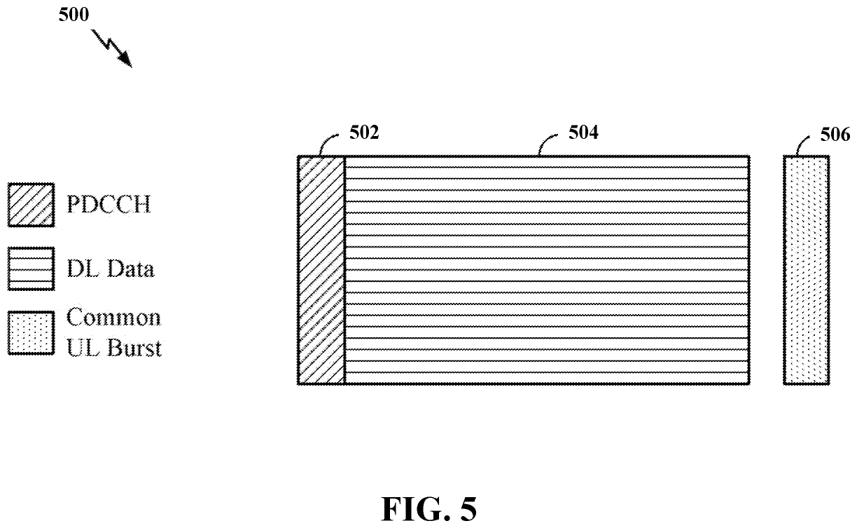

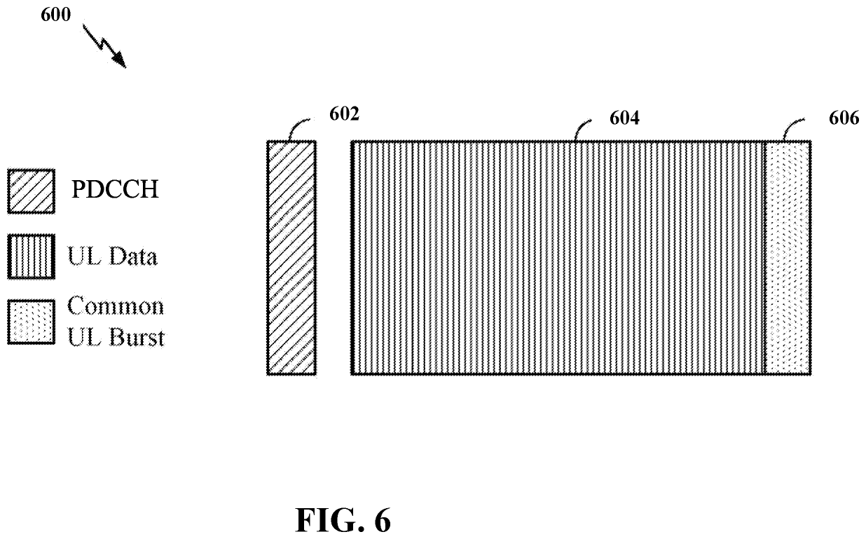

New radio (NR) may refer to radios configured to operate according to a new air interface (e.g., other than Orthogonal Frequency Divisional Multiple Access (OFDMA)-based air interfaces) or fixed transport layer (e.g., other than Internet Protocol (IP)). NR may utilize OFDM with a cyclic prefix (CP) on the uplink and downlink and may include support for half-duplex operation using time division duplexing (TDD). NR may include Enhanced Mobile Broadband (eMBB) service targeting wide bandwidth (e.g. 80 MHz beyond), millimeter wave (mmW) targeting high carrier frequency (e.g. 60 GHz), massive MTC (mMTC) targeting non-backward compatible MTC techniques, and/or mission critical targeting ultra-reliable low latency communications (URLLC) service. A single component carrier bandwidth of 100 MHz may be supported. In one example, NR resource blocks (RBs) may span 12 sub-carriers with a sub-carrier bandwidth of 60 kHz over a 0.125 ms duration or a bandwidth of 15 kHz over a 0.5 ms duration. Each radio frame may consist of 20 or 80 subframes (or NR slots) with a length of 10 ms. Each subframe may indicate a link direction (i.e., DL or UL) for data transmission and the link direction for each subframe may be dynamically switched. Each subframe may include DL/UL data as well as DL/UL control data. UL and DL subframes for NR may be as described in more detail below with respect to FIGS. 5 and 6.

The NR RAN may include a central unit (CU) and distributed units (DUs). A NR BS (e.g., gNB, 5G Node B, Node B, transmission reception point (TRP), access point (AP)) may correspond to one or multiple BSs. NR cells can be configured as access cells (ACells) or data only cells (DCells). For example, the RAN (e.g., a central unit or distributed unit) can configure the cells. DCells may be cells used for carrier aggregation or dual connectivity and may not be used for initial access, cell selection/reselection, or handover. In some cases DCells may not transmit synchronization signals (SS) in some cases DCells may transmit SS. NR BSs may transmit downlink signals to UEs indicating the cell type. Based on the cell type indication, the UE may communicate with the NR BS. For example, the UE may determine NR BSs to consider for cell selection, access, handover, and/or measurement based on the indicated cell type.

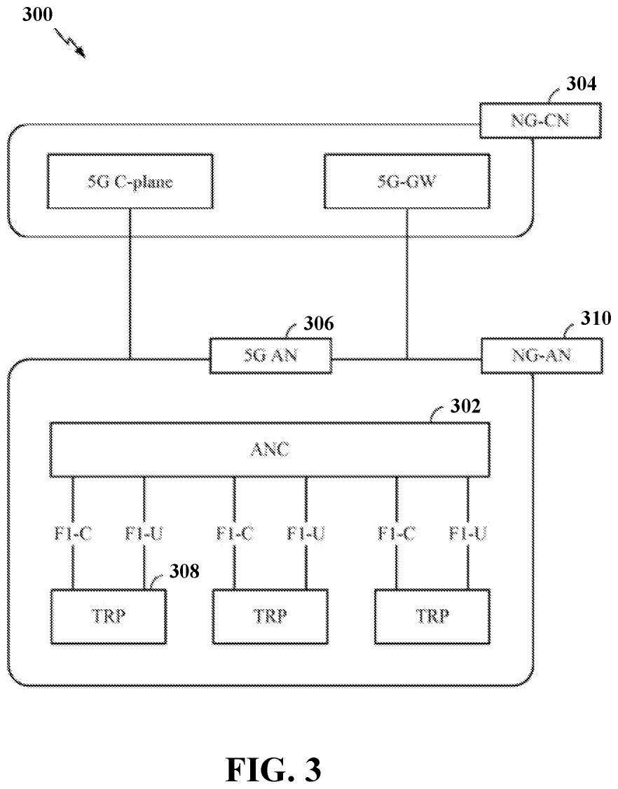

FIG. 3 illustrates an example logical architecture of a distributed RAN 300, according to aspects of the present disclosure. A 5G access node 306 may include an access node controller (ANC) 302. The ANC may be a central unit (CU) of the distributed RAN. The backhaul interface to the next generation core network (NG-CN) 304 may terminate at the ANC. The backhaul interface to neighboring next generation access nodes (NG-ANs) 310 may terminate at the ANC. The ANC may include one or more TRPs 308 (which may also be referred to as BSs, NR BSs, Node Bs, 5G NBs, APs, or some other term). As described above, a TRP may be used interchangeably with “cell.”

The TRPs 308 may be a distributed unit (DU). The TRPs may be connected to one ANC (ANC 302) or more than one ANC (not illustrated). For example, for RAN sharing, radio as a service (RaaS), and service specific ANC deployments, the TRP may be connected to more than one ANC. A TRP may include one or more antenna ports. The TRPs may be configured to individually (e.g., dynamic selection) or jointly (e.g., joint transmission) serve traffic to a UE.

The local architecture of the distributed RAN 300 may be used to illustrate fronthaul definition. The architecture may be defined that support fronthauling solutions across different deployment types. For example, the architecture may be based on transmit network capabilities (e.g., bandwidth, latency, and/or jitter). The architecture may share features and/or components with LTE. According to aspects, the next generation AN (NG-AN) 310 may support dual connectivity with NR. The NG-AN may share a common fronthaul for LTE and NR.

The architecture may enable cooperation between and among TRPs 308. For example, cooperation may be preset within a TRP and/or across TRPs via the ANC 302. According to aspects, no inter-TRP interface may be needed/present.

According to aspects, a dynamic configuration of split logical functions may be present within the architecture of the distributed RAN 300. The PDCP, RLC, MAC protocol may be adaptably placed at the ANC or TRP.

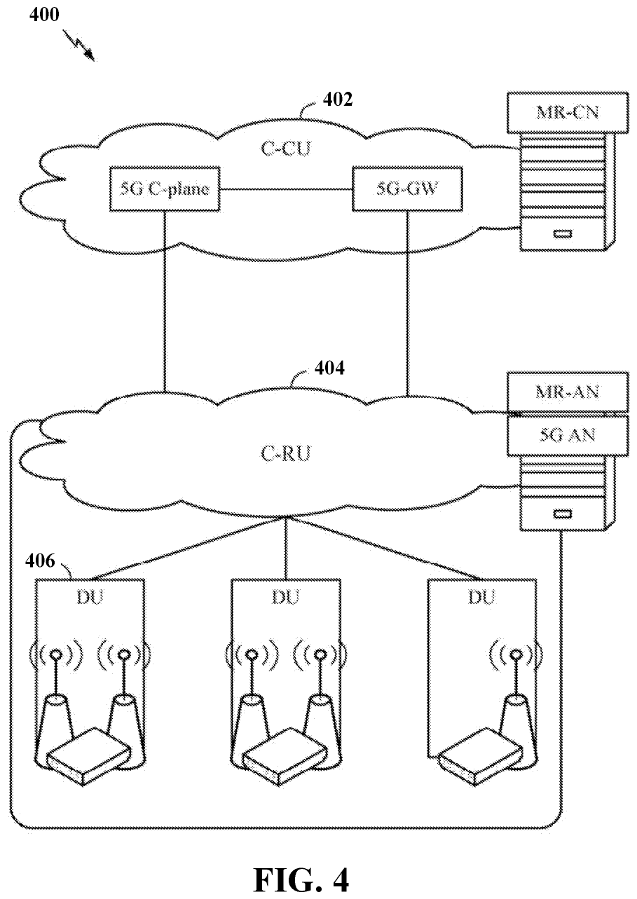

FIG. 4 illustrates an example physical architecture of a distributed RAN 400, according to aspects of the present disclosure. A centralized core network unit (C-CU) 402 may host core network functions. The C-CU may be centrally deployed. C-CU functionality may be offloaded (e.g., to advanced wireless services (AWS)), in an effort to handle peak capacity. A centralized RAN unit (C-RU) 404 may host one or more ANC functions. Optionally, the C-RU may host core network functions locally. The C-RU may have distributed deployment. The C-RU may be closer to the network edge. A distributed unit (DU) 406 may host one or more TRPs. The DU may be located at edges of the network with radio frequency (RF) functionality.

FIG. 5 is a diagram 500 showing an example of a DL-centric subframe. The DL-centric subframe may include a control portion 502. The control portion 502 may exist in the initial or beginning portion of the DL-centric subframe. The control portion 502 may include various scheduling information and/or control information corresponding to various portions of the DL-centric subframe. In some configurations, the control portion 502 may be a physical DL control channel (PDCCH), as indicated in FIG. 5. The DL-centric subframe may also include a DL data portion 504. The DL data portion 504 may sometimes be referred to as the payload of the DL-centric subframe. The DL data portion 504 may include the communication resources utilized to communicate DL data from the scheduling entity (e.g., UE or BS) to the subordinate entity (e.g., UE). In some configurations, the DL data portion 504 may be a physical DL shared channel (PDSCH).

The DL-centric subframe may also include a common UL portion 506. The common UL portion 506 may sometimes be referred to as an UL burst, a common UL burst, and/or various other suitable terms. The common UL portion 506 may include feedback information corresponding to various other portions of the DL-centric subframe. For example, the common UL portion 506 may include feedback information corresponding to the control portion 502. Non-limiting examples of feedback information may include an ACK signal, a NACK signal, a HARQ indicator, and/or various other suitable types of information. The common UL portion 506 may include additional or alternative information, such as information pertaining to random access channel (RACH) procedures, scheduling requests (SRs), and various other suitable types of information.

As illustrated in FIG. 5, the end of the DL data portion 504 may be separated in time from the beginning of the common UL portion 506. This time separation may sometimes be referred to as a gap, a guard period, a guard interval, and/or various other suitable terms. This separation provides time for the switch-over from DL communication (e.g., reception operation by the subordinate entity (e.g., UE)) to UL communication (e.g., transmission by the subordinate entity (e.g., UE)). One of ordinary skill in the art will understand that the foregoing is merely one example of a DL-centric subframe and alternative structures having similar features may exist without necessarily deviating from the aspects described herein.

FIG. 6 is a diagram 600 showing an example of an UL-centric subframe. The UL-centric subframe may include a control portion 602. The control portion 602 may exist in the initial or beginning portion of the UL-centric subframe. The control portion 602 in FIG. 6 may be similar to the control portion 502 described above with reference to FIG. 5. The UL-centric subframe may also include an UL data portion 604. The UL data portion 604 may sometimes be referred to as the pay load of the UL-centric subframe. The UL portion may refer to the communication resources utilized to communicate UL data from the subordinate entity (e.g., UE) to the scheduling entity (e.g., UE or BS). In some configurations, the control portion 602 may be a physical DL control channel (PDCCH).

As illustrated in FIG. 6, the end of the control portion 602 may be separated in time from the beginning of the UL data portion 604. This time separation may sometimes be referred to as a gap, guard period, guard interval, and/or various other suitable terms. This separation provides time for the switch-over from DL communication (e.g., reception operation by the scheduling entity) to UL communication (e.g., transmission by the scheduling entity). The UL-centric subframe may also include a common UL portion 606. The common UL portion 606 in FIG. 6 may be similar to the common UL portion 506 described above with reference to FIG. 5. The common UL portion 606 may additionally or alternatively include information pertaining to channel quality indicator (CQI), sounding reference signals (SRSs), and various other suitable types of information. One of ordinary skill in the art will understand that the foregoing is merely one example of an UL-centric subframe and alternative structures having similar features may exist without necessarily deviating from the aspects described herein.

In some circumstances, two or more subordinate entities (e.g., UEs) may communicate with each other using sidelink signals. Real-world applications of such sidelink communications may include public safety, proximity services, UE-to-network relaying, vehicle-to-vehicle (V2V) communications, Internet of Everything (IoE) communications, IoT communications, mission-critical mesh, and/or various other suitable applications. Generally, a sidelink signal may refer to a signal communicated from one subordinate entity (e.g., UE1) to another subordinate entity (e.g., UE2) without relaying that communication through the scheduling entity (e.g., UE or BS), even though the scheduling entity may be utilized for scheduling and/or control purposes. In some examples, the sidelink signals may be communicated using a licensed spectrum (unlike wireless local area networks, which typically use an unlicensed spectrum).

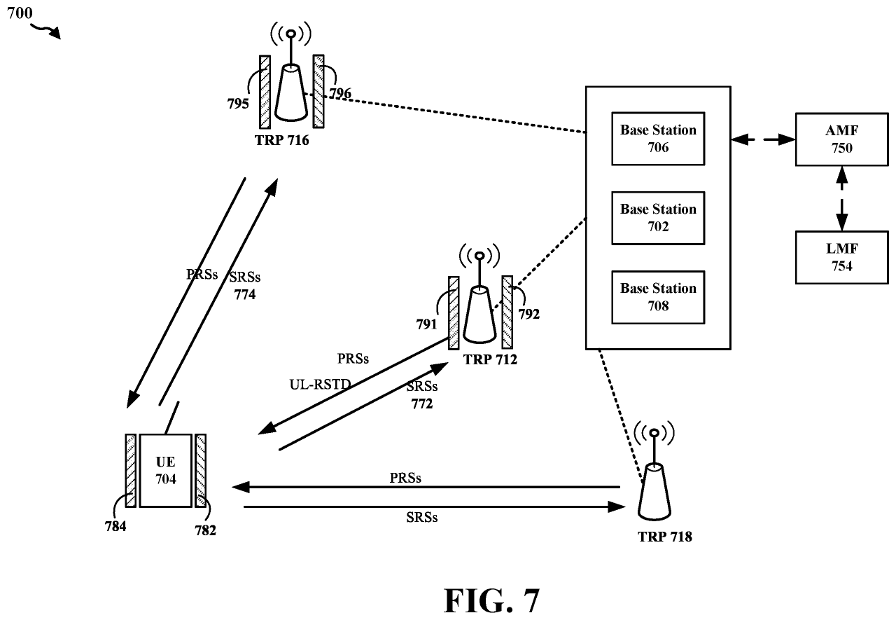

FIG. 7 is a diagram 700 illustrating communications among transmission and reception point (TRP) and user equipment (UE). In this example, a UE 704 may be in communication with one or more of a TRP-1 712, a TRP-2 716, and a TRP-3 718. Further, each of the TRP-1 712, the TRP-2 716, and the TRP-3 718 may be operated by one of a base station 702, a base station 706, and a base station 708. The UE 704 has an antenna-panel-I 782 and an antenna-panel-II 784. The TRP-1 712 has an antenna-panel-A 791 and an antenna-panel-B 792. The TRP-2 716 has an antenna-panel-C 795 and an antenna-panel-D 796.

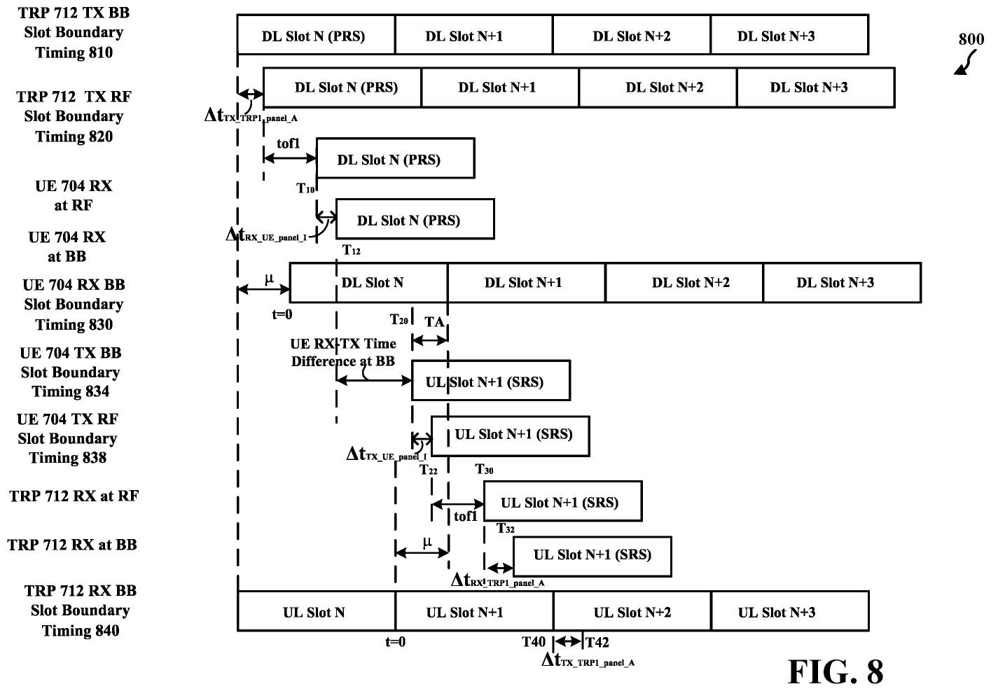

FIG. 8 is another diagram 800 illustrating communications between TRPs and a UE. A baseband of the TRP-1 712 operates according to TRP1-TX-baseband slot boundary timing 810 including DL slots N to (N+3). Baseband signals, including positioning reference signals, generated at the baseband are passed through a TX RF chain of the antenna-panel-A 791 of the TRP-1 712 to generate corresponding radio frequency (RF) signals. The TX RF chain may include a digital to analog audio converter (DAC), a filter, an external power amplifier (PA), and a diplexer/switch. The antenna-panel-A 791 transmits the RF signals in the DL slots N to (N+3) according to a TRP1-TX-RF slot boundary timing 820. The TRP1-TX-RF slot boundary timing 820 is delayed by a Δt_{TX_TRP1_panel_A} comparing to the TRP1-TX-baseband slot boundary timing 810.

After a time of flight, in this example, tof1, the UE 704 starts to receive, at T₁₀, the signals (including PRSs) transmitted from the TRP-1 712 in the DL slot N at the antenna-panel-I 782. The signals pass through an RX RF chain (e.g., including a diplexer/switch, an external low-noise amplifier (LNA), a filter, and an analog-to-digital converter (ADC)) of the antenna-panel-I 782 and arrive at the baseband of the UE 704 at T₁₂ after a delay of Δt_{RX_UE_panel_I}.

The baseband of the UE 704 determines the DL slots N to (N+3) in accordance with a UE-RX-baseband slot boundary timing 830. In this example, the start boundary of the DL slot N is a time reference point 0. The DL slot N according to the UE-RX-baseband slot boundary timing 830 has a delay of μ after the DL slot N according to the TRP1-TX-baseband slot boundary timing 810.

More specifically, the UE 704 starts to receives the DL slot N at the antenna-panel-I 782 at:

T₁₀=Δt_{TX_TRP1_panel_A}+tof1−μ.

The baseband of the UE 704 starts to receive the DL slot N at:

T₁₂=T₁₀+Δt_{RX_UE_panel_I}=Δt_{TX_TRP1_panel_A}+tof1−μ+Δt_{RX_UE_panel_I}.

Subsequently, in response to receiving the signals (including PRSs) in DL slot N from the TRP-1 712, the UE 704 may transmit signals (including souding reference signals (SRSs)) in the UL slot (N+1) to the TRP-1 712 in accordance with a UE-TX-baseband slot boundary timing 834. More specifically, the baseband of the UE 704 starts generating baseband signals of the UL slot (N+1) at:

T₂₀=one slot period−TA,
where one slot period is the time duration of a slot and TA is timing advance. The baseband signals (including SRSs) generated at the baseband are passed through a TX RF chain of the antenna-panel-I 782 of the UE 704 to generate RF signals. The TX RF chain may include a DAC, a filter, an external PA, diplexer/switch. The antenna-panel-I 782 transmits RF signals at T₂₂ according to a UE-TX-RF slot boundary timing 838, which is Δt_{TX_UE_panel_I} after the UE-TX-baseband slot boundary timing 834. Accordingly,

T₂₂=one slot period−TA+Δt_{TX_UE_panel_I}.

An RX baseband of the TRP-1 712 operates according to a TRP1-RX-baseband slot boundary timing 840, which is aligned with the TRP1-TX-baseband slot boundary timing 810. At the TRP-1 712, the start boundary of the UL slot (N+1) is a time reference point 0. In this example, after tof1, the TRP-1 712 receives, at T₃₀, the signals in the UL slot (N+1) at the antenna-panel-A 791. Accordingly,

T₃₀=μ−TA+Δt_{TX_UE_panel_I}+tof1.

The signals pass through an RX RF chain (e.g., including a diplexer/switch, external LNA, filter, and ADC) of the antenna-panel-A 791 and arrive at the baseband of the TRP-1 712 at T₃₂ after a delay of Δt_{RX_TRP1_panel_A}. Accordingly,

T₃₂=T₃₀+ΔtR_{RX_TRP1_panel_A}=μ−TA+Δt_{TX_UE_panel_I}+tof1+Δt_{RX_TRP1_panel_A}.

In response to receiving the signals in the UL slot (N+1), the TRP-1 712 may start transmitting signals in a DL slot (N+2). More specifically, the TRP-1 712, at T₄₀, start transmitting at the baseband.

T₄₀ is the start boundary of the DL slot (N+2). Accordingly,

T₄₀=one slot period.

Similar to what was described supra, after a Δt_{TX_TRP1_panel_A} at T₄₂, the antenna-panel-A 791 of the TRP-1 712 start to transmit the signals in the DL slot (N+2). Accordingly,

T₄₂=one slot period+Δt_{TX_TRP1_panel_A}.

The UE 704 may measure a [UE RX−TX difference_{baseband}] at the baseband. The [UE RX−TX difference_{baseband}] indicates the time difference between the the time point at which the UE 704 starts to receive a signal and the time point at which the UE 704 starts to transmit a signal in response (e.g., an uplink slot that is closest in time to the received downlink slot) at the baseband. In this example, at the baseband,

[UE RX−TX difference_{baseband}]=T₁₂−T₂₀=Δt_{TX_TRP1_panel_A}+tof1−μ+Δt_{RX_UE_panel_I}−one slot period+TA.

Further, the UE 704 may also calculate a [UE RX−TX differenceₐₙₜₑₙₙₐ] with respect to the TX antenna and the RX antenna of the UE 704. The [UE RX−TX difference_{baseband}] indicates the time difference between the time point at which the UE 704 starts to receive a signal at the RX antenna and the time point at which the UE 704 starts to transmit a signal at the TX antenna in response. In this example,

[UE RX−TX differenceₐₙₜₑₙₙₐ]=T₁₀-T₂₂=Δt_{TX_TRP1_panel_A}+tof1−μ−one slot period+TA−Δt_{TX_UE_panel_I}.

Accordingly, the difference between [UE RX−TX difference_{baseband}] and the [UE RX−TX differenceₐₙₜₑₙₙₐ] is as follows:

[UE RX−TX differenceₐₙₜₑₙₙₐ]−[UE RX−TX difference_{baseband}]=Δt_{TX_UE_panel_I}+Δt_{RX_UE_panel_I}.

In certain configurations, the UE 704 can estimate/measure Δt_{TX_UE_panel_I}+Δt_{RX_UE_panel_I}, which is the delay sum of the TX group delay and the RX group delay at the antenna-panel-I 782. Then, the UE 704 can compensate the [UE RX−TX difference_{baseband}] measured at the baseband to derive [UE RX−TX differenceₐₙₜₑₙₙₐ], and then report the derived [UE RX−TX differenceₐₙₜₑₙₙₐ] to its serving base station (e.g., the base station 702), which forwards the information to a LMF 754 via a AMF 750. Similarly, the UE 704 can estimate/measure a delay sum of a TX group delay and a RX group delay at the antenna-panel-II 784, and generate a corresponding [UE RX−TX differenceₐₙₜₑₙₙₐ], which can be reported to the serving base station.

Similarly, the TRP-1 712 may measure a [gNB RX−TX difference_{baseband}] at the baseband. The [gNB RX−TX difference_{baseband}] indicates the time difference between the time point at which the TRP-1 712 starts to receive a signal and the time point at which the TRP-1 712 starts to transmit a signal in response (e.g., an downlink slot that is closest in time to the received uplink slot) at the baseband. In this example, at the baseband,

[gNB RX−TX difference_{baseband}]=T₃₂−T₄₀=μ−TA+Δt_{TX_UE_panel_I}+tof1+Δt_{RX_TRP1_panel_A}−one slot period.

Further, the TRP-1 712 may also calculate a [gNB RX−TX differenceₐₙₜₑₙₙₐ] with respect to the TX antenna and the RX antenna of the TRP-1 712. The [gNB RX−TX difference_{baseband}] indicates the time difference between the time point at which the TRP-1 712 starts to receive a signal at the RX antenna and the time point at which the TRP-1 712 starts to transmit a signal at the TX antenna in response. In this example,

[gNB RX−TX differenceₐₙₜₑₙₙₐ]=T₃₀−T₄₂=μ−TA+Δt_{TX_UE_panel_I}+tof1−one slot period−Δt_{TX_TRP1_panel_A}.

Accordingly, the difference between [gNB RX−TX difference_{baseband}] and the [gNB RX−TX differenceₐₙₜₑₙₙₐ] is as follows:

[gNB RX−TX differenceₐₙₜₑₙₙₐ]−[gNB RX−TX difference_{baseband}]=Δt_{TX_TRP1_panel_A}+Δt_{RX_TRP1_panel_A}.

In certain configurations, the serving base station (e.g., the base station 702) of the TRP-1 712 can estimate/measure Δt_{TX_TRP1_panel_A}+Δt_{RX_TRP1_panel_A}, which is the delay sum of the TX group delay and the RX group delay at the antenna-panel-A 791. Then, the TRP-1 712 can compensate the [gNB RX−TX difference_{baseband}] measured at the baseband with the delay sum to derive [gNB RX−TX differenceₐₙₜₑₙₙₐ]. Similarly, the TRP-1 712 can estimate/measure a delay sum of a TX group delay and a RX group delay at the antenna-panel-B 792, and generate a corresponding [gNB RX−TX difference antenna]. Further,

[UE RX−TX differenceₐₙₜₑₙₙₐ]+[gNB RX−TX differenceₐₙₜₑₙₙₐ]=2*tof1.

Accordingly, the value of tof1 can be derived.

When the UE 704 calculates the [UE RX−TX differenceₐₙₜₑₙₙₐ] as described supra, the UE 704 needs to determine or estimate a first TA value (TA1) at T₂₀ for use in the calculation. TA1 is an estimation as the UE 704 does not actually transmit signals at T₂₀ in certain circumstances.

Accordingly, the UE 704 calculates:

[UE RX−TX differenceₐₙₜₑₙₙₐ]′=Δt_{TX_TRP1_panel_A}+tof1−μ−one slot period+TA1−Δt_{TX_UE_panel_I}.

In this calculation, the UE 704 does not transmit SRSs at T₂₀. TA1 is a pre-defined (intended) timing advance for up-coming potential uplink transmission.

When the TRP-1 712 calculates the [gNB RX−TX differenceₐₙₜₑₙₙₐ], the TRP-1 712 receives signals transmitted from the UE 704 at T₂₀ using a second TA value (TA2). Accordingly, the TRP-1 712 calculates:

[gNB RX−TX differenceₐₙₜₑₙₙₐ]′=μ−TA2+Δt_{TX_UE_panel_I}+tof1−one slot period−Δt_{TX_TRP1_panel_A}.

For this calculation, the UE 704 transmits SRSs at T₂₀, and the TA2 is the actual timing advance used for the SRS transmission. In certain circumstances, TA1 and TA2 may have the same value. In certain circumstances, TA1 and TA2 may have different values.

In certain configurations, when the UE 704 reports [UE RX−TX difference_{baseband}] or [UE RX−TX differenceₐₙₜₑₙₙₐ] to its serving base station, UE also reports the pre-defined timing advance value TA1 which is used to compute [UE RX−TX difference_{baseband}] or [UE RX−TX differenceₐₙₜₑₙₙₐ]. A time stamp for the measurement is also reported. A TA value is calculated as follows:

TA=(N_{TA}+N_{TA,offset})*T_{c}.

The UE 704 can report the TA1 value in an information element (IE) or report values of the N_{TA} and N_{TA,offset} components separately in an IE to its serving base station.

In certain scenarios, the UE 704 transmits SRSs at T₂₀ to the TRP-1 712 for measuring [gNB RX−TX difference_{baseband}] or [gNB RX−TX differenceₐₙₜₑₙₙₐ] using TA2 as described supra. The UE 704 may determine whether the values of TA1 and TA2 are the same. When the values are not the same, the UE 704 may also report a TA adjustment, which is TA2−TA1, to its serving base station.

The serving base station further forwards the information to the LMF 754. The UE 704 may also report the time stamp for the SRS transmission (e.g., at T₂₀). When TA1 is equal to TA2, then the UE 704 may not need to report the TA adjustment.

As described supra, the UE 704 may calculate [UE RX−TX differenceₐₙₜₑₙₙₐ] based on the delay sum (Δt_{TX_UE_panel_I}+Δt_{RX_UE_panel_I}) of the antenna-panel-I 782. The TRP-1 712 may calculate [gNB RX−TX differenceₐₙₜₑₙₙₐ] based on the delay sum (Δt_{TX_TRP1_panel_A}+Δt_{RX_TRP1_panel_A}) of the antenna-panel-A 791.

In certain configurations, the UE 704 and the TRP-1 712 (through their serving base stations) may report the statistics (variance, uncertainty level) of the delay sums of the associated antenna panels in use to the LMF 754. Furthermore, the combination of [UE RX−TX differenceₐₙₜₑₙₙₐ] and [gNB RX−TX differenceₐₙₜₑₙₙₐ] can be used to cancel each other's the TX group delays, which are (Δt_{TX_TRP1_panel_A}−Δt_{TX_UE_panel_I}) and (Δt_{TX_UE_panel_I}−Δt_{TX_TRP1_panel_A}) residing in DL and UL measurements respectively. Then in order to do a proper pairing for cancellation, the UE 704 may also report the identity of the TX antenna panel (RF chain) used for SRS transmission. The TRP-1 712 may also report the TX antenna panel (RF chain) used for PRSs transmission.

As such, there is an association between the assumed (not actual) SRS transmission and the panel RF used. The UE 704 provide this association to LMF 754 within [UE RX−TX difference_{baseband}] or [UE RX−TX differenceₐₙₜₑₙₙₐ] measurement report, as different panels/RF chain may have different group delays.

When a UE or TRP compensates a measurement associated with an antenna panel and performed at the baseband with a delay sum of a TX group delay and a RX group delay of that antenna panel, the compensated result can be used as, or considered as equivalent to, a measurement performed at the antenna. Further, as described supra, the delay sum of the TX group delay and the RX group delay cancels the RX group delay term within the measurement at baseband. Therefore, there is no RX group delay term within the measurement at antenna.

When a UE has measurements using different pairs of RX and TX antenna panels, after RX+TX group delay compensation, it is equivalent that all the measurements are conducted by using a same RX antenna panel but with a different TX antenna panel. The UE can send indications of the RX−TX time difference at antenna to the location management function via its serving base station. The indications may be an RX index indicating a RX antenna panel or a delay error level (or timing error group (TEG)) of the RX antenna panel. The indications may be a TX index indicating a TX antenna panel or a delay error level (or timing error group (TEG)) of the TX antenna panel. The range of the RX index is 1. Antenna panels having similar group delays (e.g., within a configured time range) are on the same delay error level or in the same TEG. The range of the TX index can be greater than 1, as UE capability for a certain band. For example, measurement A reports the associated RX index=0 and TX index=0; measurement B reports the associated RX index=0 and TX index=1; and measurement C reports the associated RX index=0 and TX index=2.

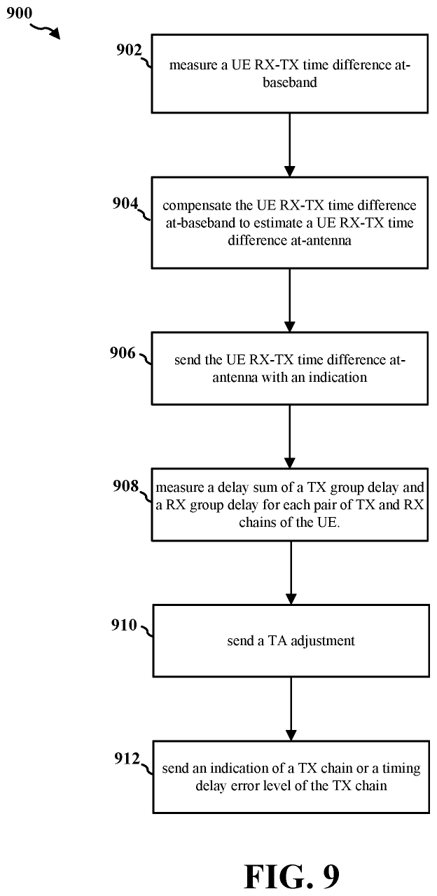

FIG. 9 is a flow chart 900 of a method (process) for determining a UE RX−TX time difference. The method may be performed by a UE (e.g., the UE 704). At operation 902, the UE measures a UE RX−TX time difference at-baseband. At operation 904, the UE compensates the UE RX−TX time difference at-baseband to estimate a UE RX−TX time difference at-antenna. At operation 906, the UE sends, to a network (e.g., the LMF 754), the UE RX−TX time difference at-antenna with an indication that reference points are at antennas and an indication of a transmission (TX) chain, or a timing delay error level of the TX chain, intended to be used by the UE during the measuring or the compensating.

In certain configurations, the UE RX−TX time difference at-baseband indicates a time difference between (a) a time point at which the UE starts to receive, at the baseband, a first downlink slot containing DL-PRSs and (b) a time point at which the UE is intended to start transmitting, at the baseband, a first uplink slot that is an uplink slot closest in time to the first downlink slot containing DL-PRSs. In certain configurations, the UE RX−TX time difference at-baseband is compensated with a first delay sum to estimate the UE RX−TX time difference at-antenna, wherein the UE RX−TX time difference at-antenna indicates a time difference between (a) a time point at which the first downlink slot containing DL-PRSs starts to be received at a reception antenna of the UE and (b) a time point at which the first uplink slot would start to be transmitted at a transmission antenna of the UE, the first delay sum being associated with a pair of TX and RX chains intended to be used by the UE to transmit the first uplink slot. In certain configurations, the TX chain is intended to be used by the UE to transmit the first uplink slot during the measuring or the compensating.

In certain configurations, the first delay sum is a sum of a TX group delay and a RX group delay at the pair of TX and RX chains intended to be used by the UE to transmit the first uplink slot. In certain configurations, the UE RX−TX time difference at-antenna is a function of a TX group delay at a transmission and reception point (TRP) of a base station, a time of flight between the UE and the TRP, a timing difference between a UE slot and a corresponding TRP slot, a TX group delay at the UE, a first TA that would be used by the UE for an intended transmission of the first uplink slot.

At operation 908, the UE measures a delay sum of a TX group delay and a RX group delay for each pair of TX and RX chains of the UE. At operation 910, the UE sends, to the network, a TA adjustment associated with a TA used by the UE for transmitting a second uplink slot containing SRSs. At operation 912, the UE sends, to the network, an indication of a TX chain, or a timing delay error level of the TX chain, used by the UE to transmit a second uplink slot containing SRSs.

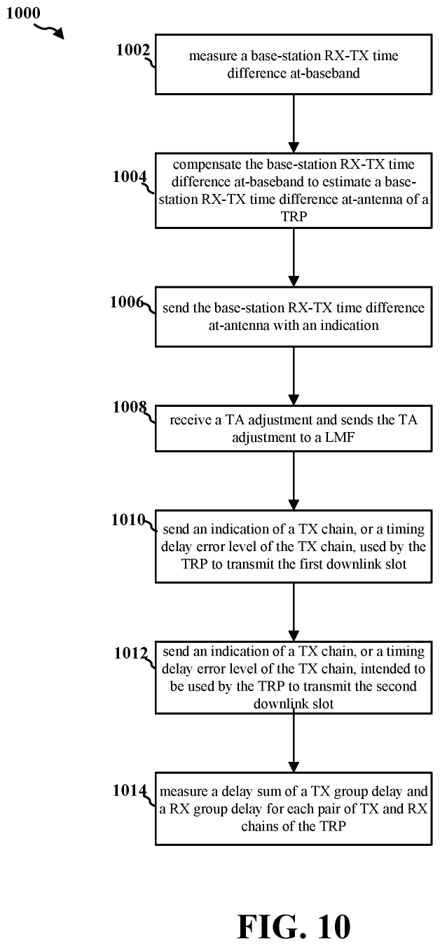

FIG. 10 is a flow chart 1000 of a method (process) for determining a base-station RX−TX time difference. The method may be performed by a base station (e.g., the base station 702). At operation 1002, the base station measures at a baseband a base-station RX−TX time difference at-baseband. At operation 1004, the base station compensates the base-station RX−TX time difference at-baseband to estimate a base-station RX−TX time difference at-antenna of a transmission and reception point (TRP) of the base station. At operation 1006, the base station sends, to a location management function, the base-station RX−TX time difference at-antenna with an indication that reference points are at antennas and an indication of a transmission (TX) chain, or a timing delay error level of the TX chain, used by the TRP during the measuring or the compensating.

In certain configurations, the base-station RX−TX time difference at-baseband indicates a time difference between (a) a time point at which the base station starts to receive, at the baseband, a second uplink slot containing SRSs from a user equipment (UE) and (b) a time point at which the base station intends to transmit, at the baseband, a second downlink slot that is a downlink slot closest in time to the second uplink slot containing SRSs. In certain configurations, the base-station RX−TX time difference at-baseband is compensated with a second delay sum to estimate the base-station RX−TX time difference at-antenna. The base-station RX−TX time difference at-antenna indicates a time difference between (a) a time point at which the second uplink slot containing SRSs starts to be received at a reception antenna of the TRP and (b) a time point at which the second downlink slot would start to be transmitted at a transmission antenna of the TRP, the second delay sum being associated with a pair of TX and RX chains intended to be used by the TRP to transmit the second downlink slot. In certain configurations, the TX chain is used by the TRP to transmit the second downlink slot during the measuring or the compensating.

In certain configurations, the second delay sum is a sum of a TX group delay and a RX group delay at the pair of TX and RX chains intended to be used by the TRP to transmit the second downlink slot. In certain configurations, the base-station RX−TX time difference at-antenna is a function of a timing difference between a UE slot and a corresponding TRP slot, a second TA used by the UE for transmitting the second uplink slot containing SRSs, a TX group delay at the UE, a time of flight between the TRP and the UE, and a TX group delay at the TRP.

At operation 1008, the base station receives a TA adjustment associated with a TA used by the UE for transmitting the second uplink slot containing SRSs. Subsequently, the base station sends the TA adjustment to the location management function. At operation 1010, the base station sends, to the location management function, an indication of a TX chain, or a timing delay error level of the TX chain, used by the TRP to transmit the first downlink slot containing DL-PRSs. At operation 1012, the base station sends, to the location management function, an indication of a TX chain, or a timing delay error level of the TX chain, intended to be used by the TRP to transmit the second downlink slot. At operation 1014, the base station measures a delay sum of a TX group delay and a RX group delay for each pair of TX and RX chains of the TRP.

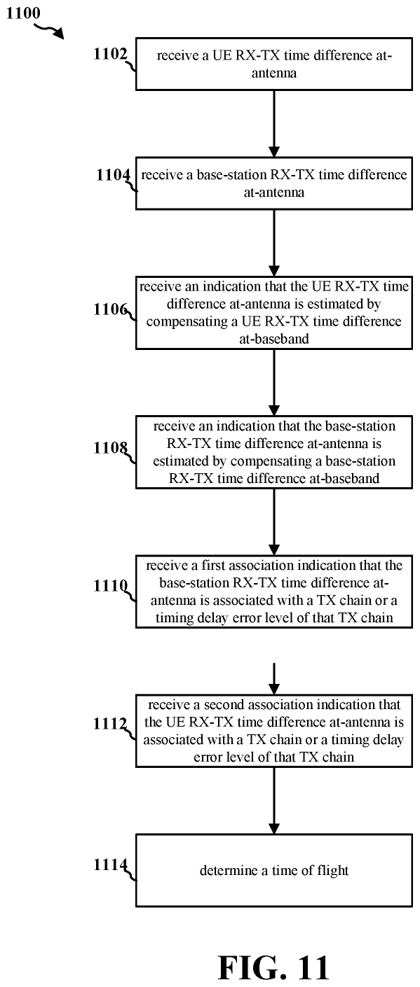

FIG. 11 is a flow chart 1100 of a method (process) for determining a time of flight. The method may be performed by a location management function (e.g., the LMF 754). At operation 1102, the location management function receives, from a base station of a UE, a UE RX−TX time difference at-antenna with an indication that reference points associated with the UE RX−TX time difference at-antenna are at antennas of the UE. At operation 1104, the location management function receives, from the base station, a base-station RX−TX time difference at-antenna with an indication that reference points associated with the base-station RX−TX time difference at-antenna are at antennas of a transmission and reception point (TRP) of the base station. At operation 1106, the location management function receives an indication that the UE RX−TX time difference at-antenna is estimated by compensating a UE RX−TX time difference at-baseband with a first delay sum of a TX group delay and a RX group delay at the UE. The UE RX−TX time difference at-antenna indicates a time difference between (a) a time point at which a first downlink slot containing DL-PRSs starts to be received at a reception antenna of the UE and (b) a time point at which a first uplink slot would start to be transmitted at a transmission antenna of the UE, wherein the first uplink slot is an uplink slot that is closest in time to the first downlink slot containing DL-PRSs and intended to be transmitted.

At operation 1108, the location management function receives an indication that the base-station RX−TX time difference at-antenna is estimated by compensating a base-station RX−TX time difference at-baseband with a second delay sum of a TX group delay and a RX group delay at the TRP. The base-station RX−TX time difference at-antenna indicates a time difference between (a) a time point at which a second uplink slot containing SRSs starts to be received at a reception antenna of a TRP of the base station and (b) a time point at which a second downlink slot would start to be transmitted at a transmission antenna of the TRP. The second downlink slot is a downlink slot that is closest in time to the second uplink slot containing SRSs and intended to be transmitted.

At operation 1110, the location management function receives a first association indication that the base-station RX−TX time difference at-antenna is associated with a TX chain or a timing delay error level of that TX chain. At operation 1112, the location management function receives a second association indication that the UE RX−TX time difference at-antenna is associated with a TX chain or a timing delay error level of that TX chain. At operation 1114, the location management function determines a time of flight of a signal transmitted between the TRP and the UE based on the UE RX−TX time difference at-antenna and the base-station RX−TX time difference at-antenna.

In certain configurations, the location management function may receive a TA adjustment associated with a TA used by the UE for transmitting an SRS in the second uplink slot containing SRSs. The time of flight is determined further based on the TA adjustment. In certain configurations, the location management function selects the UE RX−TX time difference at-antenna and the base-station RX−TX time difference at-antenna based on (a) associations with the TX chain of the TRP and the TX chain of the UE or (b) associations with timing delay error level s of the TX chain of the TRP and the TX chain of the UE. The location management function performs a calculation of combining the UE RX−TX time difference at-antenna and the base-station RX−TX time difference at-antenna to determine the time of flight between the TRP and the UE.

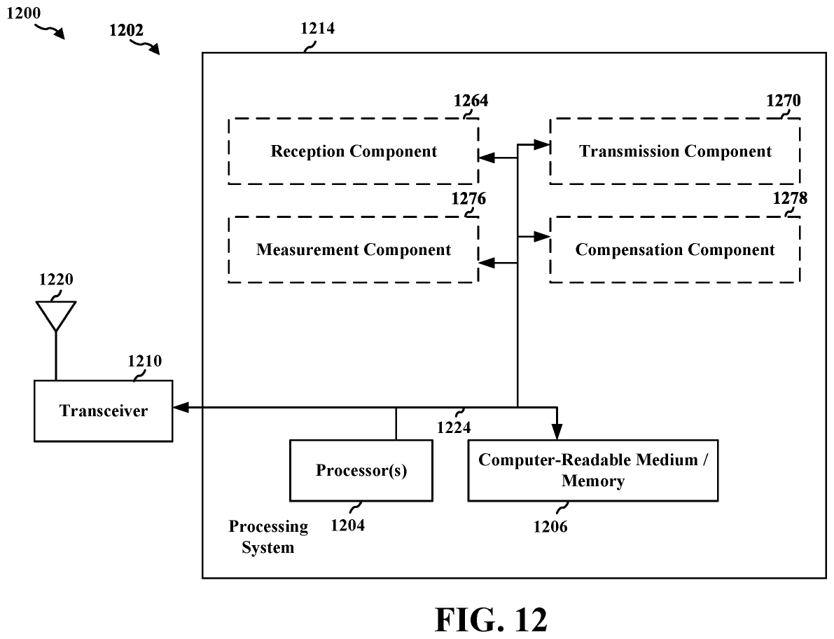

FIG. 12 is a diagram 1200 illustrating an example of a hardware implementation for an apparatus 1702 employing a processing system 1214. The apparatus 1702 may be a base station. The processing system 1214 may be implemented with a bus architecture, represented generally by a bus 1224. The bus 1224 may include any number of interconnecting buses and bridges depending on the specific application of the processing system 1214 and the overall design constraints. The bus 1224 links together various circuits including one or more processors and/or hardware components, represented by one or more processors 1204, a reception component 1764, a transmission component 1770, a measuring component 1776, and a compensation component 1778, and a computer-readable medium/memory 1206. The bus 1224 may also link various other circuits such as timing sources, peripherals, voltage regulators, and power management circuits, etc.

The processing system 1214 may be coupled to a transceiver 1210, which may be one or more of the transceivers 254. The transceiver 1210 is coupled to one or more antennas 1220, which may be the communication antennas 220.

The transceiver 1210 provides a means for communicating with various other apparatus over a transmission medium. The transceiver 1210 receives a signal from the one or more antennas 1220, extracts information from the received signal, and provides the extracted information to the processing system 1214, specifically the reception component 1764. In addition, the transceiver 1210 receives information from the processing system 1214, specifically the transmission component 1770, and based on the received information, generates a signal to be applied to the one or more antennas 1220.

The processing system 1214 includes one or more processors 1204 coupled to a computer-readable medium/memory 1206. The one or more processors 1204 are responsible for general processing, including the execution of software stored on the computer-readable medium/memory 1206. The software, when executed by the one or more processors 1204, causes the processing system 1214 to perform the various functions described supra for any particular apparatus. The computer-readable medium/memory 1206 may also be used for storing data that is manipulated by the one or more processors 1204 when executing software. The processing system 1214 further includes at least one of the reception component 1764, the transmission component 1770, the compensation component 1778, and the measuring component 1776. The components may be software components running in the one or more processors 1204, resident/stored in the computer readable medium/memory 1206, one or more hardware components coupled to the one or more processors 1204, or some combination thereof. The processing system 1214 may be a component of the base station 210 and may include the memory 276 and/or at least one of the TX processor 216, the RX processor 270, and the controller/processor 275.

In one configuration, the apparatus 1702 for wireless communication includes means for performing each of the operations of FIG. 10. The aforementioned means may be one or more of the aforementioned components of the apparatus 1702 and/or the processing system 1214 of the apparatus 1702 configured to perform the functions recited by the aforementioned means.

As described supra, the processing system 1214 may include the TX Processor 216, the RX Processor 270, and the controller/processor 275. As such, in one configuration, the aforementioned means may be the TX Processor 216, the RX Processor 270, and the controller/processor 275 configured to perform the functions recited by the aforementioned means.

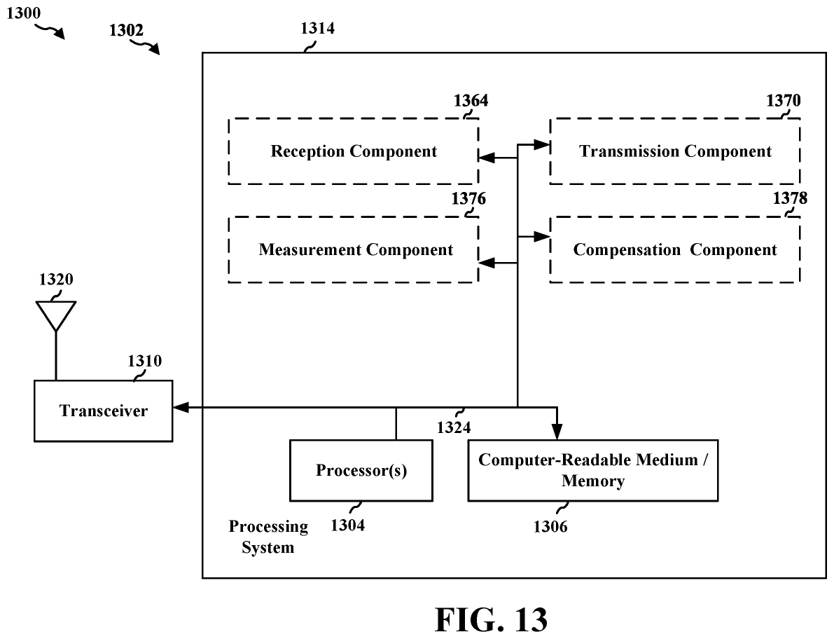

FIG. 13 is a diagram 1300 illustrating an example of a hardware implementation for an apparatus 1302 employing a processing system 1314. The apparatus 1302 may be a UE. The processing system 1314 may be implemented with a bus architecture, represented generally by a bus 1324. The bus 1324 may include any number of interconnecting buses and bridges depending on the specific application of the processing system 1314 and the overall design constraints. The bus 1324 links together various circuits including one or more processors and/or hardware components, represented by one or more processors 1304, a reception component 1364, a transmission component 1370, a compensation component 1378, a measurement component 1376, and a computer-readable medium/memory 1306. The bus 1324 may also link various other circuits such as timing sources, peripherals, voltage regulators, and power management circuits, etc.

The processing system 1314 may be coupled to a transceiver 1310, which may be one or more of the transceivers 254. The transceiver 1310 is coupled to one or more antennas 1320, which may be the communication antennas 252.

The transceiver 1310 provides a means for communicating with various other apparatus over a transmission medium. The transceiver 1310 receives a signal from the one or more antennas 1320, extracts information from the received signal, and provides the extracted information to the processing system 1314, specifically the reception component 1364. In addition, the transceiver 1310 receives information from the processing system 1314, specifically the transmission component 1370, and based on the received information, generates a signal to be applied to the one or more antennas 1320.

The processing system 1314 includes one or more processors 1304 coupled to a computer-readable medium/memory 1306. The one or more processors 1304 are responsible for general processing, including the execution of software stored on the computer-readable medium/memory 1306. The software, when executed by the one or more processors 1304, causes the processing system 1314 to perform the various functions described supra for any particular apparatus. The computer-readable medium/memory 1306 may also be used for storing data that is manipulated by the one or more processors 1304 when executing software. The processing system 1314 further includes at least one of the reception component 1364, the transmission component 1370, the compensation component 1378, and the measurement component 1376. The components may be software components running in the one or more processors 1304, resident/stored in the computer readable medium/memory 1306, one or more hardware components coupled to the one or more processors 1304, or some combination thereof. The processing system 1314 may be a component of the UE 250 and may include the memory 260 and/or at least one of the TX processor 268, the RX processor 256, and the communication processor 259.

In one configuration, the apparatus 1302 for wireless communication includes means for performing each of the operations of FIG. 9. The aforementioned means may be one or more of the aforementioned components of the apparatus 1302 and/or the processing system 1314 of the apparatus 1302 configured to perform the functions recited by the aforementioned means.

As described supra, the processing system 1314 may include the TX Processor 268, the RX Processor 256, and the communication processor 259. As such, in one configuration, the aforementioned means may be the TX Processor 268, the RX Processor 256, and the communication processor 259 configured to perform the functions recited by the aforementioned means.

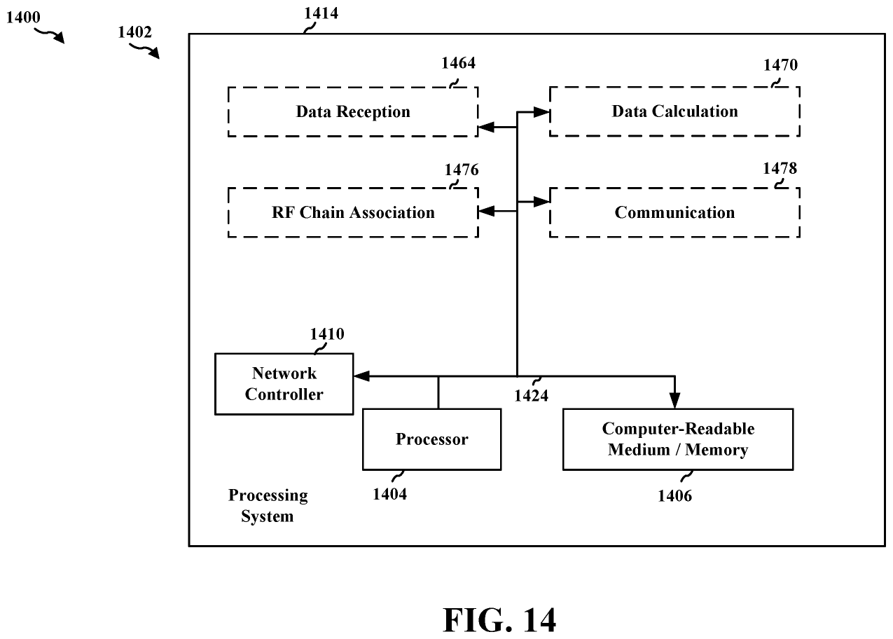

FIG. 14 is a diagram 1400 illustrating an example of a hardware implementation for an apparatus 1402 employing a processing system 1414 and one or more other hardware components. The apparatus 1402 may implement the location management function. The processing system 1414 may be implemented with a bus architecture, represented generally by the bus 1424. The bus 1424 may include any number of interconnecting buses and bridges depending on the specific application of the processing system 1414 and the overall design constraints. The bus 1424 links together various circuits including one or more processors and/or hardware components, represented by the processor 1404, the computer-readable medium/memory 1406, a network controller 1410, etc.

The bus 1424 may also link various other circuits such as timing sources, peripherals, voltage regulators, and power management circuits, which are well known in the art, and therefore, will not be described any further.

The processing system 1414 may be coupled to the network controller 1410. The network controller 1410 provides a means for communicating with various other apparatus over a network. The network controller 1410 receives a signal from the network, extracts information from the received signal, and provides the extracted information to the processing system 1414, specifically a communication component 1478. In addition, the network controller 1410 receives information from the processing system 1414, specifically the communication component 1478, and based on the received information, generates a signal to be sent to the network. The processing system 1414 includes a processor 1404 coupled to a computer-readable medium/memory 1406. The processor 1404 is responsible for general processing, including the execution of software stored on the computer-readable medium/memory 1406. The software, when executed by the processor 1404, causes the processing system 1414 to perform the various functions described supra for any particular apparatus. The computer-readable medium/memory 1406 may also be used for storing data that is manipulated by the processor 1404 when executing software. The processing system further includes at least one of a ***data reception component 1464, a data calculation component 1470, and a RF chain association component 1476. The components may be software components running in the processor 1404, resident/stored in the computer readable medium/memory 1406, one or more hardware components coupled to the processor 1404, or some combination thereof.

The apparatus 1402 has means for performing operations described supra referring to FIG. 11. The aforementioned means may be one or more of the aforementioned components of the apparatus 1402 and/or the processing system 1414 of the apparatus 1402 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication of a user equipment (UE), comprising:
measuring, at a baseband of the UE, a UE RX−TX time difference at-baseband;
compensating the UE RX−TX time difference at-baseband to estimate a UE RX−TX time difference at-antenna; and
sending, to a network, the UE RX−TX time difference at-antenna with an indication that reference points are at antennas and an indication of a transmission (TX) chain, or a timing delay error level of the TX chain, intended to be used by the UE during the measuring or the compensating.

2. The method of claim 1, wherein the UE RX−TX time difference at-baseband indicates a time difference between (a) a time point at which the UE starts to receive, at the baseband, a first downlink slot containing DL-PRSs and (b) a time point at which the UE is intended to start transmitting, at the baseband, a first uplink slot that is an uplink slot closest in time to the first downlink slot containing DL-PRSs;
wherein the UE RX−TX time difference at-baseband is compensated with a first delay sum to estimate the UE RX−TX time difference at-antenna, wherein the UE RX−TX time difference at-antenna indicates a time difference between (a) a time point at which the first downlink slot containing DL-PRSs starts to be received at a reception antenna of the UE and (b) a time point at which the first uplink slot would start to be transmitted at a transmission antenna of the UE, the first delay sum being associated with a pair of TX and RX chains intended to be used by the UE to transmit the first uplink slot; and
wherein the TX chain is intended to be used by the UE to transmit the first uplink slot during the measuring or the compensating.

3. The method of claim 2, wherein the first delay sum is a sum of a TX group delay and a RX group delay at the pair of TX and RX chains intended to be used by the UE to transmit the first uplink slot.

4. The method of claim 2, wherein the UE RX−TX time difference at-antenna is a function of a TX group delay at a transmission and reception point (TRP) of a base station, a time of flight between the UE and the TRP, a timing difference between a UE slot and a corresponding TRP slot, a TX group delay at the UE, a first TA that would be used by the UE for an intended transmission of the first uplink slot.

5. The method of claim 1, further comprising:
measuring a delay sum of a TX group delay and a RX group delay for each pair of TX and RX chains of the UE.

6. The method of claim 1, further comprising:
sending, to the network, a timing advance (TA) adjustment associated with a TA used by the UE for transmitting a second uplink slot containing SRSs.

7. The method of claim 1, further comprising:
sending, to the network, an indication of a TX chain, or a timing delay error level of the TX chain, used by the UE to transmit a second uplink slot containing SRSs.

8. A method of wireless communication of a base station comprising:
measuring, at a baseband of the base station, a base-station RX−TX time difference at-baseband;
compensating the base-station RX−TX time difference at-baseband to estimate a base-station RX−TX time difference at-antenna of a transmission and reception point (TRP) of the base station;
sending, to a location management function, the base-station RX−TX time difference at-antenna with an indication that reference points are at antennas and an indication of a transmission (TX) chain, or a timing delay error level of the TX chain, used by the TRP during the measuring or the compensating.

9. The method of claim 8, wherein the base-station RX−TX time difference at-baseband indicates a time difference between (a) a time point at which the base station starts to receive, at the baseband, a second uplink slot containing SRSs from a user equipment (UE) and (b) a time point at which the base station intends to transmit, at the baseband, a second downlink slot that is a downlink slot closest in time to the second uplink slot containing SRSs;
wherein the base-station RX−TX time difference at-baseband is compensated with a second delay sum to estimate the base-station RX−TX time difference at-antenna, wherein the base-station RX−TX time difference at-antenna indicates a time difference between (a) a time point at which the second uplink slot containing SRSs starts to be received at a reception antenna of the TRP and (b) a time point at which the second downlink slot would start to be transmitted at a transmission antenna of the TRP, the second delay sum being associated with a pair of TX and RX chains intended to be used by the TRP to transmit the second downlink slot; and
wherein the TX chain is used by the TRP to transmit the second downlink slot during the measuring or the compensating.

10. The method of claim 9, wherein the second delay sum is a sum of a TX group delay and a RX group delay at the pair of TX and RX chains intended to be used by the TRP to transmit the second downlink slot.

11. The method of claim 9, wherein the base-station RX−TX time difference at-antenna is a function of a timing difference between a UE slot and a corresponding TRP slot, a second TA used by the UE for transmitting the second uplink slot containing SRSs, a TX group delay at the UE, a time of flight between the TRP and the UE, and a TX group delay at the TRP.

12. The method of claim 9, further comprising:
receiving a timing advance (TA) adjustment associated with a TA used by the UE for transmitting the second uplink slot containing SRSs; and
sending the TA adjustment to the location management function.

13. The method of claim 9, further comprising:
sending, to the location management function, an indication of a TX chain, or a timing delay error level of the TX chain, used by the TRP to transmit the first downlink slot containing DL-PRSs; and
sending, to the location management function, an indication of a TX chain, or a timing delay error level of the TX chain, intended to be used by the TRP to transmit the second downlink slot.

14. The method of claim 8, further comprising:
measuring a delay sum of a TX group delay and a RX group delay for each pair of TX and RX chains of the TRP.

15. A method of operating a location management function, comprising:
receiving, from a base station of a UE, a UE RX−TX time difference at-antenna with an indication that reference points associated with the UE RX−TX time difference at-antenna are at antennas of the UE;
receiving, from the base station, a base-station RX−TX time difference at-antenna with an indication that reference points associated with the base-station RX−TX time difference at-antenna are at antennas of a transmission and reception point (TRP) of the base station;
receiving a first association indication that the base-station RX−TX time difference at-antenna is associated with a TX chain or a timing delay error level of that TX chain;
receiving a second association indication that the UE RX−TX time difference at-antenna is associated with a TX chain or a timing delay error level of that TX chain; and
determining a time of flight of a signal transmitted between the TRP and the UE based on the UE RX−TX time difference at-antenna and the base-station RX−TX time difference at-antenna.

16. The method of claim 15, further comprising:
receiving an indication that the UE RX−TX time difference at-antenna is estimated by compensating a UE RX−TX time difference at-baseband with a first delay sum of a TX group delay and a RX group delay at the UE, wherein the UE RX−TX time difference at-antenna indicates a time difference between (a) a time point at which a first downlink slot containing DL-PRSs starts to be received at a reception antenna of the UE and (b) a time point at which a first uplink slot would start to be transmitted at a transmission antenna of the UE, wherein the first uplink slot is an uplink slot that is closest in time to the first downlink slot containing DL-PRSs and intended to be transmitted; or
receiving an indication that the base-station RX−TX time difference at-antenna is estimated by compensating a base-station RX−TX time difference at-baseband with a second delay sum of a TX group delay and a RX group delay at the TRP, wherein the base-station RX−TX time difference at-antenna indicates a time difference between (a) a time point at which a second uplink slot containing SRSs starts to be received at a reception antenna of a TRP of the base station and (b) a time point at which a second downlink slot would start to be transmitted at a transmission antenna of the TRP, wherein the second downlink slot is a downlink slot that is closest in time to the second uplink slot containing SRSs and intended to be transmitted.

17. The method of claim 16, further comprising:
receiving a timing advance (TA) adjustment associated with a TA used by the UE for transmitting an SRS in the second uplink slot containing SRSs, wherein the time of flight is determined further based on the TA adjustment.

18. The method of claim 15, further comprising:
selecting the UE RX−TX time difference at-antenna and the base-station RX−TX time difference at-antenna based on (a) associations with the TX chain of the TRP and the TX chain of the UE or (b) associations with timing delay error level s of the TX chain of the TRP and the TX chain of the UE; and
performing a calculation of combining the UE RX−TX time difference at-antenna and the base-station RX−TX time difference at-antenna to determine the time of flight between the TRP and the UE.
